(19) United States
(12) Patent Application Publication
(10) Pub. No.: US 2011/0267467 A1
(43) Pub. Date: Nov. 3, 2011

(54) In-vehicle camera apparatus enabling recognition of tail lamp of distant preceding vehicle

(75) Inventors: Takayuki Kimura, Kariya-shi (JP); Takekazu Terui, Kariya-shi (JP)

(73) Assignee: DENSO CORPORATION, Kariya-city (JP)

(21) Appl. No.: 13/066,865

(22) Filed: Apr. 27, 2011

(30) Foreign Application Priority Data
Apr. 28, 2010 (JP) 2010-103822

(51) Int. Cl. H04N 7/18

(52) U.S. Cl. 348/148; 348/E07.085

(57) ABSTRACT

A camera apparatus installated on a vehicle includes an image sensor having a RGB Bayer array of pixel sensors and a beam-splitting optical filter disposed between the camera lens assembly and the Bayer array. An incident light beam from a source such as a distant vehicle tail lamp becomes split into a plurality of light beams which become focused on respectively separate pixel sensors. Since the color of the light source is detected based on a plurality of pixel sensors, erroneous detection due to light falling on only a single R, G or B pixel sensor is prevented.

### CROSS-REFERENCE TO RELATED APPLICATIONS

This application is based on and incorporates herein by reference Japanese Patent Application No. 2010-103822 filed on Apr. 28, 2010.

### BACKGROUND OF THE INVENTION

1. Field of Application

The present invention relates to a camera apparatus for installation on a host vehicle, enabling reliable discrimination between a red-color light source consisting of a tail lamp of a preceding vehicle and an orange-color light source consisting of a headlamp or a reflector of another vehicle.

In particular, the invention relates to such an apparatus, whereby a tail lamp of a preceding vehicle can be reliably identified within a captured image even when the preceding vehicle is substantially distant from the host vehicle.

2. Description of Related Art

A system referred to as an AHB (Automatic High-Beam) system is known, which automatically switches the headlamps of a vehicle between the high-beam condition and the low-beam condition. This form of automatic headlamp control is sometimes referred to as Hi-Lo control.

Such an AHB system utilizes an in-vehicle camera apparatus (where “camera apparatus” is used herein to refer to electronic types of image-capture apparatus in general) installed in a host vehicle, which discriminates between headlamps and tail lamps of other vehicles, appearing within images captured by the camera apparatus. The camera apparatus generally utilizes a type of image sensor, having a Bayer array of pixels sensors that are variously sensitive to R (red), G (green) and B (blue) components of incident light. Such pixel sensors, are referred to herein simply as “pixels” for brevity. The color at any position within a captured image is obtained based on demosaicing processing (e.g., averaging) of respective color values derived by a set of R, G and B pixels at that position, such as a 2×2 block (RGGB block) of the RGB pixels. An image of the external scene ahead of the host vehicle is focused on the image sensor by a lens assembly of the camera apparatus. When another vehicle is relatively close to the host vehicle and is a preceding vehicle, a tail lamp of the other vehicle can be identified as a red-color region within an image captured by the in-vehicle camera apparatus, while a headlamp or reflector of another vehicle can be identified as an orange-color region. Hence it is possible to reliably distinguish between tail lamps and headlamps or reflectors of other vehicles when these are relatively close. Such an apparatus is described for example in Japanese patent application publication No. 2004-189229.

However problems arises with utilizing a Bayer type of image sensor in is such an application. When light is received from a source which is substantially distant and hence appears as a point source, the size of a resultant light spot which falls on the image sensor may be smaller than a RGGB pixel block of the Bayer array. In particular, the light spot may fall on only a single pixel. In that case, if for example the color of the point light source is orange, and this falls only on a R (red-sensitive) pixel, the color will be detected as being red. Hence, orange-color light that is transmitted from a reflector or headlamp of a distant vehicle may be erroneously detected as arriving from a tail lamp. This is referred to as the “false color” effect.

Thus with such a prior art type of apparatus, reliable discrimination between tail lamps and reflectors (or headlamps) of other vehicles can only be achieved when these vehicles are not distant from the host vehicle.

To attempt to overcome this false color problem, it is possible to defocus the optical image which is formed by the camera lens on the image sensor. The size of a light spot (corresponding to a point light source) formed as on the surface of the image sensor can thereby be increased. However this results in blurring of the image that is captured by the camera apparatus, and a lowering of the signal/noise ratio, so that tail lamps of other vehicles cannot be reliably identified from the captured image.

### SUMMARY OF THE INVENTION

It is an objective of the present invention to overcome the above problem, by providing an in-vehicle camera apparatus employing a Bayer type of image sensor, which can reliably distinguish between orange-color light sources and red-color light sources (such as tail lamps of preceding vehicles) even when these are of small size and located at a substantial distance from a host vehicle of the camera apparatus.

To achieve this the invention provides an in-vehicle camera apparatus having an image sensor, a lens assembly, an infra-red blocking filter and a beam-splitting optical filter. The image sensor comprises a RGB Bayer array of is pixels (sensor elements) which respectively detect the R (red), G (green) and B (blue) components of light. The lens assembly focuses a beam of external incident light upon the RGB Bayer array. When light is received from a distant small source such as a tail lamp of a distant preceding vehicle, the beam-splitting optical filter splits the corresponding beam of focused light into a plurality of light beams which become incident on respectively different ones of the RGB pixels of the RGB Bayer array.

Thus for example when the incident light entering the lens assembly 20 is orange light from a reflector or headlamp of a distant vehicle, so that a resultant plurality of orange-color beams fall upon respective RGB pixels, the orange color will be detected based on levels of color components that are respectively detected by R, G and B pixels. Hence the orange color can be reliably distinguished from red color. In the case of red light from a tail lamp of a distant vehicle, only the red component will be detected, by the R pixels, so that the tail lamp will be reliably identified.

Since external incident light becomes focused on the RGB Bayer array, a higher S/N ratio can be achieved than is possible with a method whereby a defocused light beam falls upon the RGB Bayer array, to increase the size of a resultant light spot as described hereinabove.

Preferably, the focused light beam from the lens assembly 20 is split into a plurality of light beams which are mutually parallel and spaced apart (horizontally and vertically) from one another by a distance substantially equal to the pitch (i.e., pixel height and width dimension) of the RGB sensor array. With a preferred embodiment, four of such light beams are formed, which become incident on respective adjacent pixels of the RGB Bayer array.

Preferably, the beam-splitting optical filter comprises a successively stacked combination of a first polarizing beam splitter, a ¼-wave plate, and a second polarizing beam splitter. The first polarizing beam splitter is oriented (i.e., has an optic axis oriented) such as to split an incident light beam into a first is linearly polarized beam and a second linearly polarized beam, having respective axes which are vertically displaced from one another, and having respective polarization directions which differ by 90 degrees. The second polarizing beam splitter is oriented such as to split the first linearly polarized beam into a third linearly polarized beam and a fourth linearly polarized beam, which are horizontally displaced from one another and have respective polarization directions which differ by 90 degrees. The second polarizing beam splitter further splits the second linearly polarized beam into a fifth linearly polarized beam and a sixth linearly polarized beam, which are horizontally displaced from one another and have respective polarization directions which differ by 90 degrees.

Furthermore preferably, the beam-splitting optical filter is configured such that the first and second linearly polarized beams are mutually parallel, and vertically separated by a predetermined distance that is substantially equal to the pixel pitch of the Bayer array, the third and fourth linearly polarized beams are mutually parallel and horizontally separated by that predetermined distance, and the fifth and sixth linearly polarized beams are mutually parallel and horizontally separated by the predetermined distance.

From another aspect, such an in-vehicle camera apparatus preferably comprises an infra-red blocking filter, for blocking an infra-red component of an externally incident light beam from passing to the RGB Bayer array. Such an infra-red blocking filter can be readily provided as a coating of magnesium fluoride, formed on a surface of a lens of the lens assembly.

Furthermore the lens assembly of such an in-vehicle camera apparatus is preferably configured to effect chrominance aberration compensation whereby respective levels of chrominance aberration of a green component and a red component of externally incident light are made substantially equal.

The lens assembly preferably includes a lens having an anti-reflection coating formed on a surface of the lens, for suppressing reflection of a red component of externally incident light.

### BRIEF DESCRIPTION OF THE DRAWINGS

FIG. 1 is a conceptual diagram illustrating the general configuration of an optical system and image sensor of a first embodiment of an in-vehicle camera apparatus;

FIG. 2 is a diagram illustrating the action of an optical system of the first embodiment upon light rays received from an external source;

FIG. 3 is a conceptual diagram corresponding to FIG. 2, illustrating separation of an incident light beam into separate beams;

FIGS. 4A, 4B, 4C are diagrams illustrating results obtained with the first embodiment and corresponding results obtainable with a prior art type of in-vehicle camera apparatus;

FIG. 5 is a conceptual diagram illustrating separation of an incident light beam into separate beams, with a second embodiment of an in-vehicle camera apparatus;

FIG. 6 is a conceptual diagram illustrating the general configuration of an optical system and image sensor of the second embodiment;

FIG. 7 is a system block diagram of an embodiment of a headlamp control apparatus incorporating an in-vehicle camera apparatus according to the present invention;

FIG. 8 is a flow diagram of a processing routine that is executed by the embodiment of FIG. 7; and

FIG. 9 illustrates examples of light spots formed by split light beams which are incident on a Bayer image sensor.

### DESCRIPTION OF PREFERRED EMBODIMENTS

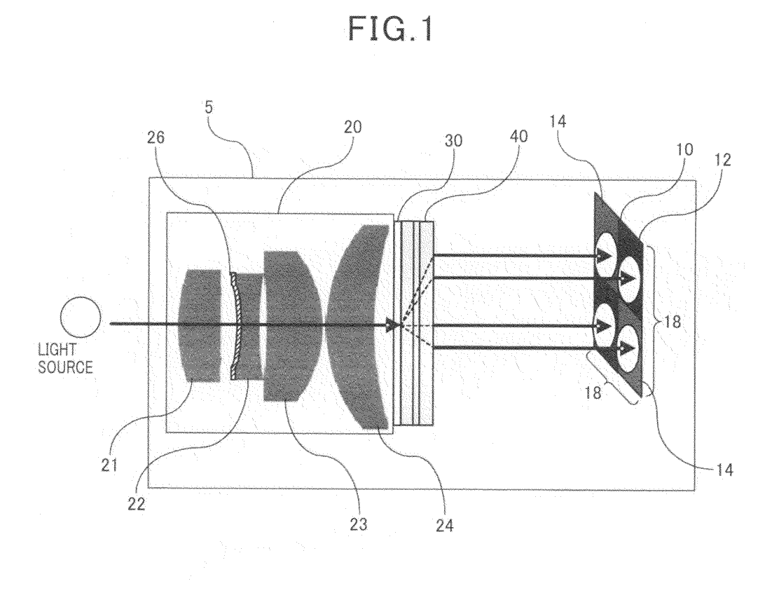

FIG. 1 is a diagram for describing a first embodiment of an in-vehicle camera apparatus, designated by numeral 5, showing a lens assembly 20 and image sensor 10 of the camera apparatus 5 in conjunction with an infra-red blocking filter 30 and a beam-splitting optical filter 40. The image sensor 10 of this embodiment is a CMOS (Complementary Metal Oxide Semiconductor) image sensor, however it would be equally possible to use a CCD (Charge Coupled Device) image sensor. The image sensor 10 is a Bayer type of sensor, formed with a RGB Bayer array 18, i.e., a planar array of pixel sensors which are respectively sensitive to the red, green and blue components of incident light and are arrayed along a first direction (designated herein as the horizontal direction) and a second direction at right angles to the first direction. The expressions “vertical” or “vertically” as used herein are to be understood as referring to a direction at right angles to a horizontal plane that is parallel to the optical axis of the lens assembly 20 and the horizontal array direction of the RGB Bayer array 18. The lens assembly 20 focuses light, received from an external light source, at a focal plane corresponding to the RGB Bayer array 18. The lens assembly 20 is configured such as to suppress chrominance aberrations and distortion of an optical image that is focused on the RGB Bayer array 18.

As shown in FIG. 1, the lens assembly 20 of this embodiment is formed of a plano-convex lens 21, a biconcave lens 22, a plano-convex lens 23 and a meniscus lens 24. These have a combination of optical properties whereby the amount of chrominance aberration of the G (green) component of incident light (as received by the RGB Bayer array 18) is substantially identical to the amount of chrominance aberration of the R (red) component of the light.

An anti-reflection coating 26 of a material such as MgF₂ or quartz is formed (by vacuum evaporative deposition or by sputtering) on the face of the biconcave lens 22 which opposes the plano-convex lens 21. This coating 26 acts to reduce the extent of reflection of the R component of incident light, relative to the extent of reflection of each of the G and B components of the incident light.

The infra-red blocking filter 30 acts to block infra-red rays which enter the lens assembly 20. With this embodiment the infra-red blocking filter 30 consists of a thin film, formed on the opposite face of the beam-splitting optical filter 40 from the RGB Bayer array 18. The infra-red blocking filter 30 is preferably formed by evaporative deposition of a material such as SiO₂ or TiO₂, to constitute a reflective type of infra-red blocking filter. However it would be equally possible to form the infra-red blocking filter 30 from glass containing an additive material such as AlO₂ or Cu.

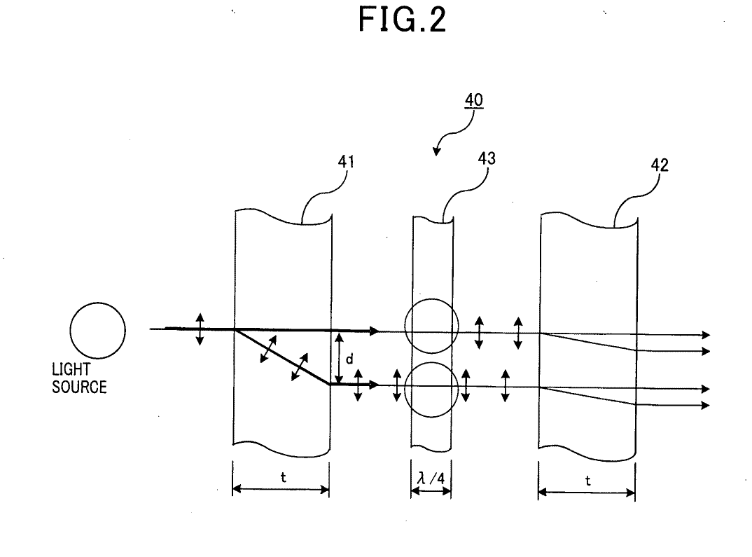

The beam-splitting optical filter 40 is disposed between the image sensor 10 and the lens assembly 20, and serves to split an incident light beam (passed through the lens assembly 20 and infra-red blocking filter 30) into four light beams which become incident on the RGB Bayer array 18 of the image sensor 10. The configuration of the beam-splitting optical filter 40 is basically as illustrated in FIG. 2, consisting of a first polarizing beam splitter 41, a ¼-wave plate 43 and a second polarizing beam splitter 42, successively stacked as shown. The term “polarizing beam splitter”, as used herein, signifies an optical device which splits an incident light ray into an ordinary ray (whose propagation direction is unchanged from the incidence direction) and an extraordinary ray whose direction is displaced from the incidence direction, with respective light beams corresponding to the ordinary ray and extraordinary ray being substantially parallel to one another, linearly polarized and having respective polarization planes which differ by 90 degrees. A light beam corresponding to the ordinary ray is referred to herein as the undeviated beam, while a light beam corresponding to the extraordinary ray is referred to as the deviated beam. With this embodiment the ordinary ray and the extraordinary ray are spaced apart by a predetermined distance d, i.e., the axes of the deviated beam and the undeviated beam are separated by the distance d.

The first polarizing beam splitter 41 is formed of a plate of quartz crystal, having an optic axis oriented at an angle of 44.83° from the direction of thickness t of the plate, i.e., displaced by that angle from a direction normal to the main planar surfaces of the plate. The first polarizing beam splitter 41 splits a randomly polarized incident light beam into an undeviated light beam and a is deviated light beam.

The vertical separation amount d is determined by the thickness t of the first polarizing beam splitter 41, and is substantially equal to the size (width and height dimension) of each pixel of the Bayer array 18, i.e., is substantially equal to the sensor pitch.

The ¼-wave plate 43 is also formed as a quartz crystal plate, having a thickness that is ¼ of the average wavelength of the light that is to be detected. When the rays of the undeviated light beam and the deviated light beam emitted from the first polarizing beam splitter 41 pass through the ¼-wave plate 43, each of the resultant pair of emitted beams from ¼-wave plate 43 is circularly polarized, i.e., is a combination of two orthogonal linearly polarized waves which differ in phase by ¼ wavelength)(90°).

The second polarizing beam splitter 42 is formed as a quartz crystal plate, configured as for the first polarizing beam splitter 41, but with the optic axis of the second polarizing beam splitter 42 rotated by 90° from the optic axis of the first polarizing beam splitter 41. The second polarizing beam splitter 42 acts to split each of the two circularly polarized light beams from the ¼-wave plate 43 into an undeviated light beam and a deviated light beam (as defined above), which are orthogonally linearly polarized and are mutually parallel and separated horizontally by the aforementioned distance d, i.e., by an amount substantially equal to the pixel pitch of the RGB Bayer array 18.

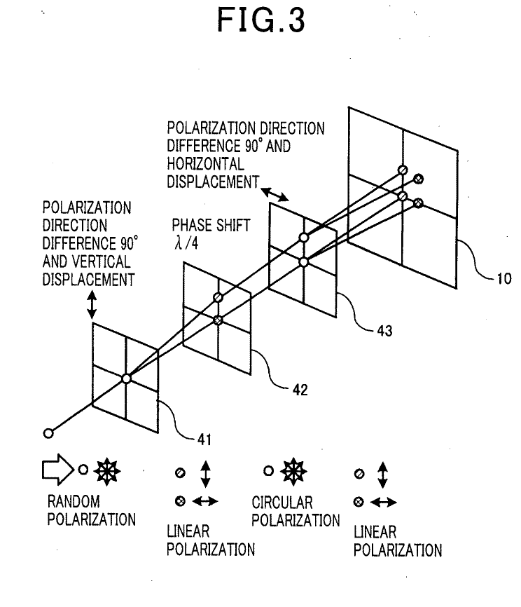

Four beams light beams thereby emerge from the second polarizing beam splitter 42, with their axes spaced apart by the distance d in a horizontal direction (at right angles to the optical axis of the lens assembly) and vertical direction, as illustrated conceptually in FIG. 3. Here, “horizontal” signifies a direction within a horizontal plane, where “horizontal plane” has the significance defined hereinabove. The result is that an incident beam of randomly polarized light (e.g., from a vehicle tail lamp or headlamp) is split into four light beams which are displaced from one another by the distance d, in the horizontal and the vertical direction, and are directed onto the RGB Bayer array 18 of the image sensor 10.

The diameter of each of the four resultant light spots which are thereby focused on the RGB Bayer array 18 is determined by the lens assembly 20 and beam-splitting optical filter 40. Preferable, when the focused light has been received from a tail lamp of a distant vehicle (with the tail lamp thereby approximating to a point source of light), the light spot diameter will not exceed the width of each of the pixels 12, 14, 16 of the RGB Bayer array 18.

In that way, as can be understood from FIG. 11, it is ensured that the “false-color” problem is effectively overcome, since it is ensured that light which is received from a point source cannot become incident on only one of the RGB pixels of the image sensor 10. It is thereby ensured that the image sensor 10 can be used to reliably discriminate between orange-color and red-color light sources. This will be true even when a red-color light source is a tail lamp of a distant vehicle.

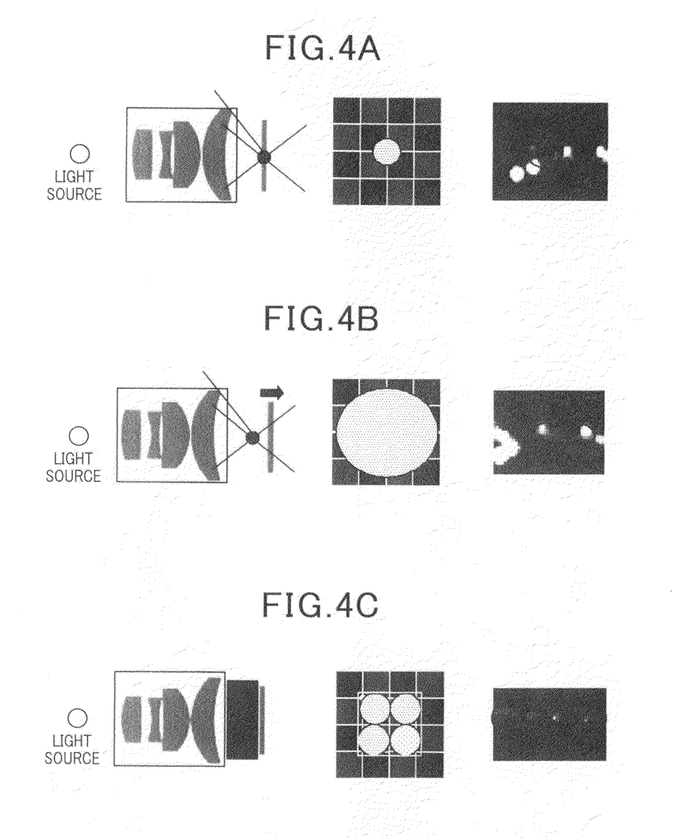

The above advantages of the first embodiment will be further described referring to FIGS. 4A, 4B and 4C. It is assumed that only image regions corresponding to tail lamps of other vehicles are to be detected in an image that is derived from the image sensor 10, i.e., red-color regions.

With a prior art type of apparatus, when incident light is received from a distant source, the resultant focused light spot on the RGB Bayer array 18 will be extremely small, and so cannot cover all of a 2×2 block (RGGB block) of pixels of the RGB Bayer array 18. This is illustrated in FIG. 4A.

In that case, if orange-colored light from a vehicle reflector falls as a light spot on a R pixel, the false-color problem will arise. That is, the average value of the output signal levels from that R pixel and from a set of immediately adjacent B and G pixels will be derived, and that value will be interpreted as corresponding to the red color. Hence the color of the light source will be erroneously detected as being red.

It would be possible to avoid this by increasing the size of the light spot corresponding to a distant light source, by adjusting the lens assembly 20 to defocus the light spot at the plane of the RGB Bayer array 18. However in that case the size of the light spot will be increased, for example such as to cover all of the area of the RGB Bayer array 18, as illustrated in FIG. 4B. Although such a method would enable the “false-color” problem to be avoided, the image would be so blurred that it would be impossible to distinguish between tail lamps and reflectors of distant vehicles.

However with the first embodiment described above, when a light beam originating from a point source (such as a tail lamp of a distant vehicle) passes through the lens assembly 20, the light beam becomes split into two pairs in the vertical direction and two pairs in the horizontal direction. Thus a corresponding set of four light spots are formed on the RGB Bayer array 18, as illustrated in FIG. 4(c). The thickness t of each of the first polarizing beam splitter 41 and second polarizing beam splitter 42 is determined such that the four light beams will be incident on respective ones of a mutually adjacent set of four of the RGB pixels 12, 14, 16 of the RGB Bayer array 18. The false-color problem is thereby avoided.

In addition, the respective optical characteristics of the lenses 21, 22, 23, 24 of the lens assembly 20 are predetermined such that the amount of chrominance aberration of the G component of incident light is identical to the amount of chrominance aberration of the R component of the light. The effects of chrominance aberration of the R and G components are thereby minimized. Hence the respective levels of the R and G components can be accurately detected. This further serves to ensure that orange light from a reflector (or headlamp) and red light from the tail lamp of another vehicle can be distinguished with reliability.

Furthermore the coating 26, formed on the lens assembly 20, suppresses reflection of the R component of the RGB components of incident light, and thereby prevents reddish-color ghost images from being produced by the lens assembly 20. Erroneous detection of apparent red light from tail lamps can thereby be avoided.

The infra-red blocking filter 30 can be readily formed, as a thin film on a surface of the beam-splitting optical filter 40, by evaporative deposition of magnesium fluoride.

The first embodiment has been described above for the case of light received from a source which is sufficiently distant to effectively constitute a point source. However in the case of a light beam received from a source other than a point source, the area covered by each of the split beams may be greater than the area of a R, G or B pixel of the RGB Bayer array 18. Hence it will be understood that in the general case, the respective axes of the light beams which emerge from the beam-splitting optical filter 40 become incident on respectively separate ones of the RGB pixels of the RGB Bayer array 18.

Similarly, it will be understood that with the first embodiment, respective axes of the pair of light beams emerging from the first polarizing beam splitter 41 are vertically separated by the distance d, while respective axes of a first pair of light beams emerging from the second polarizing beam splitter 42 are horizontally separated by the distance d, as are also the respective axes of the second pair of light beams which emerge from the second polarizing beam splitter 42.

### Second Embodiment

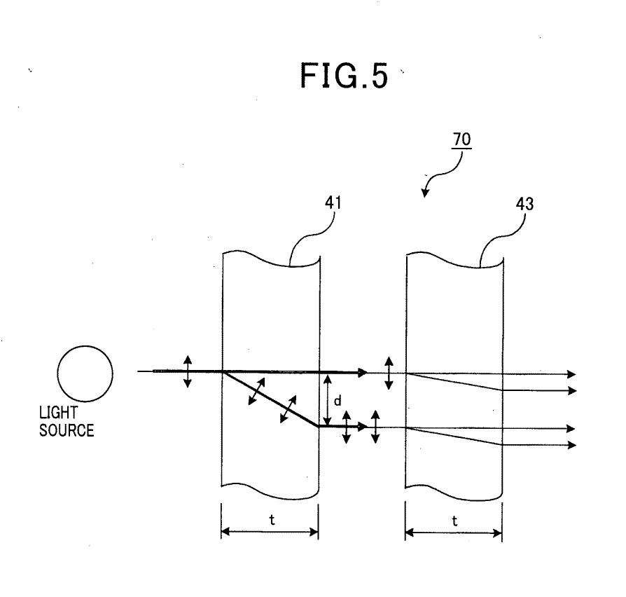

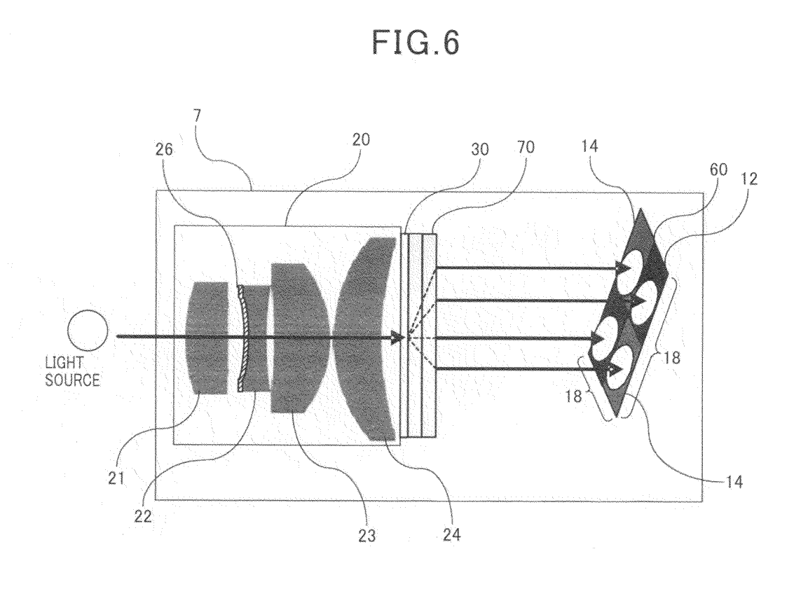

A second embodiment will be described referring to FIGS. 5 and 6. FIG. 5 shows the general configuration of a beam-splitting optical filter 70 of this embodiment, which is a modified form of the beam-splitting optical filter 40 of the first embodiment. FIG. 6 shows the general configuration of a in-vehicle camera apparatus 7 of this embodiment. Since the second embodiment differs from the first embodiment only with respect to the beam-splitting optical filter 70 and the image sensor 10, only these will be described in detail in the following.

As shown in FIG. 5, the beam-splitting optical filter 70 of this embodiment differs from that of the first embodiment in that the ¼-wave plate 43 is eliminated. In addition, the image sensor 60 of the RGB Bayer array 18 of the second embodiment is inclined at an angle of 45 degrees with respect to a horizontal plane which is parallel to the optical axis of the lens assembly 20 (i.e., which is at right angles to the main planar faces of the beam-splitting optical filter 40).

With the in-vehicle camera apparatus 7 of this embodiment, as for the first embodiment, an incident light beam which enters the first polarizing beam splitter 41 emerges as an undeviated light beam and a deviated light beam, i.e., as two parallel linearly polarized beams having polarization planes which differ by 90d, separated by the vertical displacement d. The second polarizing beam splitter 42 splits each of the undeviated beam and deviated beam from the first polarizing beam splitter 41 into a corresponding beam pair, with the beams of each pair being separated horizontally by the distance d. Thus as illustrated in FIG. 5, a total of four light beams are obtained, as for the first embodiment. However with the second embodiment, these light beams are inclined at 45 degrees from the aforementioned horizontal plane.

Hence with the second embodiment, as illustrated in FIG. 6, the image sensor 10 is disposed such that the RGB Bayer array 18 is inclined at 45 degrees from that horizontal plane, positioned such that the four light beams from the second polarizing beam splitter 42 become incident on the RGB Bayer array 18 along directions at right angles to the plane of the RGB Bayer array 18. However the second embodiment has the advantage that it is unnecessary to provide the ¼-wave plate 43 of the first embodiment, with only the first polarizing beam splitter 41 and the second polarizing beam splitter 42 being required to constitute the beam-splitting optical filter 70. Hence, the apparatus can be made compact.

### Third Embodiment

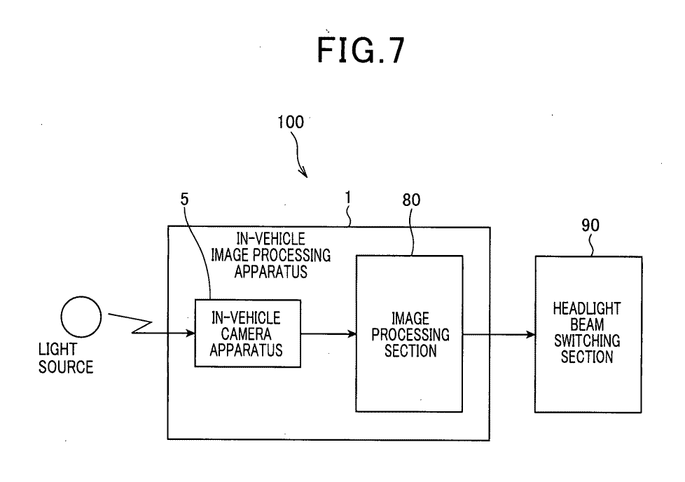

An embodiment of a headlamp control apparatus 100, for executing automatic control of switching between the high-beam and low-beam conditions of vehicle headlamps, will be described referring first to the overall configuration shown in FIG. 7. As shown in FIG. 7, the headlamp control apparatus 100 includes a in-vehicle image processing apparatus 1 and a headlamp switching section 90. The in-vehicle image processing apparatus 1 is formed of an in-vehicle camera apparatus 5 and an image processing section 80, however it would be equally possible to instead utilize the in-vehicle camera apparatus 7 of the second embodiment. The image processing section 80 includes a microcomputer having a CPU, ROM, RAM and I/O sections (not shown in the drawings), which repetitively executes a processing routine in accordance with a program held in the ROM. The processing routine basically consists of four successive stages, designated as (A), (B), (C) and (D), as follows:

(A) Acquire an image from the in-vehicle camera apparatus 5

(B) Extract an image region expressing a tail lamp of another vehicle, from the acquired image.

(C) Based on the intra-image position of the extracted tail lamp, judge whether the distance of the other vehicle from the host vehicle exceeds a predetermined distance.

(D) Output the judgement results obtained in step (C), to the headlamp switching section 90.

Based on the judgement results thus obtained from the image processing section 80, the headlamp switching section 90 performs changeover between the high-beam and low-beam conditions of the headlamps of the host vehicle.

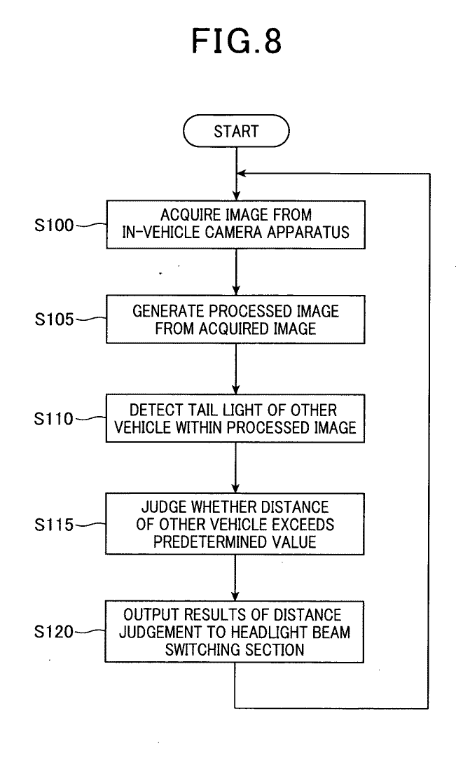

The above processing executed by the image processing section 80 will be described in more detail referring to the flow diagram of FIG. 8. Firstly (step S100), information expressing a new image (i.e., color and luminance information) is acquired from the in-vehicle camera apparatus 5. Next in step S105, the acquired image is processed to obtain a corresponding bi-level image. The contents of the bi-level image are then judged, to detect each outline corresponding to a possible tail lamp (i.e., positioned within a detected outline corresponding to another vehicle). The possible positions of tail lamps within the original image are thereby obtained.

Next (step S110), for each of these objects which are possible tail lamp, the corresponding color information is judged. If the corresponding color is red, then the object is judged to be an actual tail lamp. In that case, the position of the tail lamp within the image is obtained,

Next in step S115, based on the intra-image position of the tail lamp, a decision is made as to whether the distance of the tail lamp from the host vehicle (i.e., distance of a preceding vehicle carrying that tail lamp) exceeds a predetermined value.

Since methods are known whereby the distance of an object captured in an image can be estimated based upon the position of the object within the image and various parameters of the camera apparatus, detailed description is omitted. For example the distance may be calculated based upon the relationship between the vertical position of a tail lamp within the image and the estimated vertical position (within the image) of a ground-based point light source that is infinitely distant. The latter position can be estimated based on known parameters of the camera apparatus, such as the orientation and height of the camera with respect to the ground surface, etc. This distance calculation is performed for each acquired image in which a tail lamp is detected.

Next (step S120), the judgement results obtained in step S115 are outputted to the headlamp switching section 90. Operation then returns to step S100, and the above image processing steps are repeated for a succeeding acquired image.

In that way, the headlamp control apparatus 100 extracts light sources from within an image that is obtained by the in-vehicle camera apparatus 5, and uses color information in the extracted information to identify light sources which correspond to tail lamps of other (preceding) vehicles, and thereby judge respective distances of such other vehicles, based upon positions at which these tail lamps appear within the acquired image.

With the present invention, it becomes possible to reliably discriminate between a light source which is a tail lamp and a light source which is a reflector of another vehicle, since the invention enables reliable discrimination between a red-color light source and an orange-color light source, even if the light source is a tail lamp which is located at a long distance from the host vehicle and so becomes effectively a point light source. This accurate discrimination between red and orange colors is achieves by eliminating the false-color effect, as described above. It thus becomes possible to reliably judge whether another vehicle is located at more than a predetermined distance from the host vehicle, by identifying a tail lamp of such a vehicle, and utilizing the position of the tail lamp within an acquired image to estimate the distance of the corresponding vehicle.

### Alternative Embodiments

With the first embodiment as shown in FIG. 2, the beam-splitting optical filter 40 is formed as a 3-layer configuration, by successively stacking the first polarizing beam splitter 41, the ¼-wave plate 43 and the second polarizing beam splitter 42, with the ¼-wave plate 43 effecting a ¼-wavelength phase shift of light which passes from the first polarizing beam splitter 41. Alternatively, similar effects to those of the first embodiment may be obtained by using a 3-layer configuration which is formed by successively stacking the first polarizing beam splitter 41, the second polarizing beam splitter 42, and a third polarizing beam splitter which is formed and oriented identically to the first polarizing beam splitter 41 (i.e., having the optic axis thereof oriented identically to that of the first polarizing beam splitter 41). However such a configuration has the disadvantage that an incident light beam becomes split into a total of eight beams, rather than four beams as with the first and second embodiments.

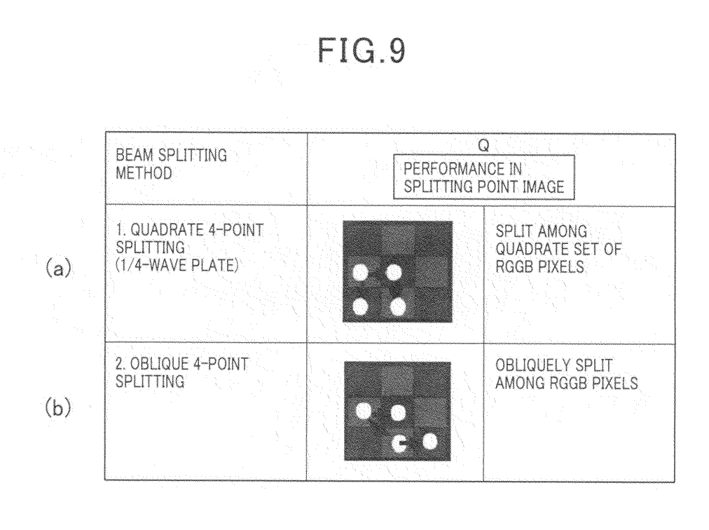

With the first embodiment, a 2×2 set of four light spots (e.g., corresponding to a light beam originating from a distant tail lamp) are formed on respective adjacent RGB pixels of the RGB Bayer array 18. With that embodiment, the plane of the RGB Bayer array 18 is at right angles to the horizontal direction (at right angles to the optical axis of the lens assembly 20). This condition is illustrated in section (a) of FIG. 9. However it would be equally possible to angularly displace the first polarizing beam splitter 41 or the second polarizing beam splitter 42 about a diagonal between two opposing corners, to an extent whereby the four light spots become diagonally displaced to the condition shown in section (b) of FIG. 9, while falling on separate respectively adjacent pixels.

The invention has been described hereinabove referring to embodiments whereby an incident light ray is split into parallel rays which are mutually separated in the vertical and horizontal directions by the amount d. However it should be understood that the scope of the invention is not limited to a condition of strict beam parallelism. Basically it is only necessary to configure the beam-splitting optical filter and its separation from the RGB Bayer sensor such that, with a plurality of light beams emerging from the beam-splitting optical filter and travelling along respective directions to attain the RGB Bayer array at respective positions thereon, the centers of these positions are separated from one another by an amount substantially equal to the pixel pitch of the array.

With the present invention, as described above, an incident light ray is split into a plurality of light rays which can attain respectively separate ones of a set of mutually adjacent RGB pixels of a Bayer image sensor. It is thereby ensured that light which originates from a point source (such as a tail lamp of a distant vehicle), and which is focused on a Bayer image sensor, will become incident on a plurality of RGB pixels rather than on a single pixel. The above-described false-color problem can thereby be eliminated.

As described hereinabove, the expressions “horizontal” and “horizontally” are used in the above description and in the appended claims to refer to a direction within a plane that is parallel to a specific array direction (horizontal array direction) of the RGB Bayer array and to the optical axis of the lens assembly of the camera apparatus, while the expressions “vertical” and “vertically” refer to a direction at right angles to such a horizontal plane.

It is to be understood that the above embodiments are illustrative of the invention but are not to be taken in a limiting sense, and that various modifications of these or alternative embodiments may be envisaged, which fall within the scope claimed for the invention.

What is claimed is:

1. An in-vehicle camera apparatus for installation on a motor vehicle, comprising a Bayer array of R (red-sensitive), G (green-sensitive) and B (blue-sensitive) pixel sensors and a lens assembly configured for focusing upon said Bayer array an incident light beam from an external light source;
wherein said in-vehicle camera apparatus comprises a beam-splitting optical filter disposed between said lens assembly and said Bayer color sensor array, for splitting said incident light beam into a plurality of polarized light beams, with respective axes of said polarized light beams oriented for incidence on respectively separate ones of said R pixel sensors, G pixel sensors and B pixel sensors.

2. An in-vehicle camera apparatus as claimed in claim 1, comprising an infra-red blocking filter disposed to block an infra-red component of said externally incident light beam.

3. An in-vehicle camera apparatus as claimed in claim 1, wherein said infra-red blocking filter comprises a coating of magnesium fluoride formed on a surface of a lens of said lens assembly.

4. An in-vehicle camera apparatus as claimed in claim 1, wherein said lens assembly is configured to effect chrominance aberration compensation whereby respective levels of chrominance aberration of a green component and of a red component of said incident light are made substantially identical to one another.

5. An in-vehicle camera apparatus as claimed in claim 1, wherein said lens assembly comprises a lens having a coating formed on a surface thereof, said coating configured for suppressing reflection of a red component of said incident light.

6. An in-vehicle camera apparatus as claimed in claim 1, wherein said beam-splitting optical filter comprises:
a first polarizing beam splitter, having an optic axis oriented for splitting said incident light beam into a first linearly polarized beam and a second linearly polarized beam with respective axes thereof vertically displaced from one another and having respective polarization directions which differ by 90 degrees; and
a second polarizing beam splitter, having an optic axis oriented for to splitting said first linearly polarized beam into a third linearly polarized beam and a fourth linearly polarized beam with respective axes thereof horizontally displaced from one another and having respective polarization directions which differ by 90 degrees, and for splitting said second linearly polarized beam into a fifth linearly polarized beam and a sixth linearly polarized beam with respective axes thereof horizontally displaced from one another and having respective polarization directions which differ by 90 degrees.

7. An in-vehicle camera apparatus as claimed in claim 6, wherein
said first linearly polarized beam and said second linearly polarized beam are mutually parallel and vertically separated by a predetermined distance, said predetermined distance being substantially equal to a pixel pitch of said Bayer array,
said third linearly polarized beam and said fourth linearly polarized beam are mutually parallel and horizontally separated by said predetermined distance, and
said fifth linearly polarized beam and said sixth linearly polarized beam are mutually parallel and horizontally separated by said predetermined distance.

8. An in-vehicle camera apparatus as claimed in claim 7, wherein said Bayer array is inclined at an angle substantially equal to 45 degrees with respect to a horizontal plane that is parallel to an optical axis of said lens assembly.

9. An in-vehicle camera apparatus as claimed in claim 6, comprising an optical quarter-wave plate disposed between said first polarizing beam splitter and said second polarizing beam splitter, for converting said first linearly polarized beam and said second linearly polarized beam to respective circularly polarized light beams.

10. An in-vehicle camera apparatus as claimed in claim 9, wherein said Bayer array is oriented perpendicular to said horizontal planes.

11. An in-vehicle camera apparatus as claimed in claim 6, wherein said beam-splitting optical filter comprises a successively stacked combination of said first polarizing beam splitter, said second polarizing beam splitter, and a third polarizing beam splitter having an optic axis oriented identically to said optic axis of said first polarizing beam splitter.

12. An in-vehicle camera apparatus for installation on a motor vehicle, comprising a Bayer array of R (red-sensitive), G (green-sensitive) and B (blue-sensitive) pixel sensors and a lens assembly configured for focusing upon said Bayer array an incident light beam from an external light source;
wherein said in-vehicle camera apparatus comprises a beam-splitting optical filter disposed between said lens and said Bayer color sensor array, for splitting said incident light beam into a plurality of polarized light beams, with respective axes of said polarized light beams oriented for incidence on respectively separate ones of said R pixel sensors, G pixel sensors and B pixel sensors, said beam-splitting optical filter comprising:
a first polarizing beam splitter, having an optic axis oriented for splitting said incident light beam into a first linearly polarized beam and a second linearly polarized beam with respective axes thereof vertically displaced from one another and having respective polarization directions which differ by 90 degrees;
an optical quarter-wave plate disposed between said first polarizing beam splitter and said second polarizing beam splitter, for converting said first linearly polarized beam and said second linearly polarized beam to a first circularly polarized beam and a second circularly polarized beam respectively; and
a second polarizing beam splitter, having an optic axis oriented for splitting said first circularly polarized beam into a third linearly polarized beam and a fourth linearly polarized beam with respective axes thereof horizontally displaced from one another and having respective polarization directions which differ by 90 degrees, and for splitting said second circularly polarized beam into a fifth linearly polarized beam and a sixth linearly polarized beam with respective axes thereof horizontally displaced from one another and having respective polarization directions which differ by 90 degrees.

13. An in-vehicle image processing apparatus installed on a host vehicle, coupled to receive image information expressing an image captured by an in-vehicle camera apparatus as claimed in claim 1, and comprising processing circuitry configured for processing said image information to:
detect respective light sources appearing within said image;
identify, from among said detected said light sources, a light source corresponding to another vehicle, with said identification being executed based on color information contained in said image information; and
calculate an estimated distance of said other vehicle from said host vehicle, based on a position of said identified light source within said captured image and upon known parameters of said camera apparatus.
